(19) United States
(12) Patent Application Publication
(10) Pub. No.: US 2005/0009537 A1
(43) Pub. Date: Jan. 13, 2005

(54) Method and apparatus for facilitating wireless presence-based services

(76) Inventors: Ronald T. Crocker, St. Charles, IL (US); John M. Harris, Chicago, IL (US); Thomas B. Hart, West Dundee, IL (US)

Correspondence Address: MOTOROLA, INC., 1303 EAST ALGONQUIN ROAD, IL01/3RD, SCHAUMBURG, IL, 60196, US

(21) Appl. No.: 10/758,735

(22) Filed: Jan. 16, 2004

Related U.S. Application Data
(60) Provisional application No. 60/486,684, filed on Jul. 11, 2003.
(60) Provisional application No. 60/527,603, filed on Dec. 5, 2003.

(51) Int. Cl. H04B 7/00

(52) U.S. Cl. 455/456.3; 455/519

(57) ABSTRACT

The need to facilitate wireless presence-based services more efficiently is addressed by embodiments of the present invention. In general, a wireless presence proxy (WPP) (131) caches presence updates (such as buddy list presence updates) from a presence server (161) for a mobile station (MS) (101). The WPP maintains presence information, which reflects the presence updates received, for transfer to the MS when an update condition exists. Thus, updates are made when, for example, a resource-efficient condition is present, such as the assignment of a traffic channel for other call activity. The WPP also updates the presence server, on behalf of the MS, when the MS presence status changes. In this manner, the embodiments described are able to reduce the system resources required to facilitate wireless presence-based services.

### REFERENCE(S) TO RELATED APPLICATION(S)

This application is related to a co-pending application entitled “METHOD AND APPARATUS FOR FACILITATING A PTT SESSION INITIATION USING AN IP-BASED PROTOCOL,” filed on even date herewith, assigned to the assignee of the present application, and hereby incorporated by reference.

This application is related to a provisional application, Ser. No. 60/486684, entitled “WIRELESS COMMUNICATIONS NETWORK AND METHOD FOR ENABLING WIRELESS PRESENCE-BASED SERVICES,” filed Jul. 11, 2003.

This application is related to a provisional application, Ser. No. 60/527603, entitled “METHOD AND APPARATUS REDUCING PTT CALL SETUP DELAYS,” filed Dec. 5, 2003.

### FIELD OF THE INVENTION

The present invention relates generally to wireless communication systems and, in particular, to facilitating wireless presence-based services in such systems.

### BACKGROUND OF THE INVENTION

Presence services, such as instant messaging (IM), are well-known to Internet users. These services are also part of 3rd generation (3G) wireless offerings. However, the current wireless paradigm does not handle these services very efficiently. For example, existing presence servers typically maintain presence information by periodically communicating with the target-mobile station (MS) and use the response or lack of it, as a presence “heart beat” signal. This pinging may occur every 5 minutes or so for each MS. FIG. 1 illustrates a simplified messaging exchange involved in pinging such, an MS. As seen in messaging flow diagram 100, the presence server ping triggers, via the packet data serving node (PDSN), substantial messaging between the base station (BS), mobile switching center (MSC), MS, packet control function (PCF), and PDSN to finally deliver the ping response to the presence server (via the PDSN). As can be seen, this paging extensively involves the MSC and A interface. It also uses long (i.e., inefficient) pages on the wireless interface to the MS. The network and MS go through a full data session activation out of dormancy (i.e., call set up with the allocation of a TCH), a packet exchange, and a tearing-down of the connection.

Moreover, presence state changes for an MS are pushed to all units that include that MS in their buddy lists. Add to all of this that each individual service may track presence independent of other services. For example, different IM services may each perform their own pinging of the target MS to obtain substantially the same information and then push substantially the same changes, independently, to units according to their buddy lists. Given the inefficiencies involved in current presence implementations, a need exists for a method and apparatus for facilitating wireless presence-based services more efficiently.

### BRIEF DESCRIPTION OF THE DRAWINGS

FIG. 1 is a messaging flow diagram of prior art messaging to support presence-based services.

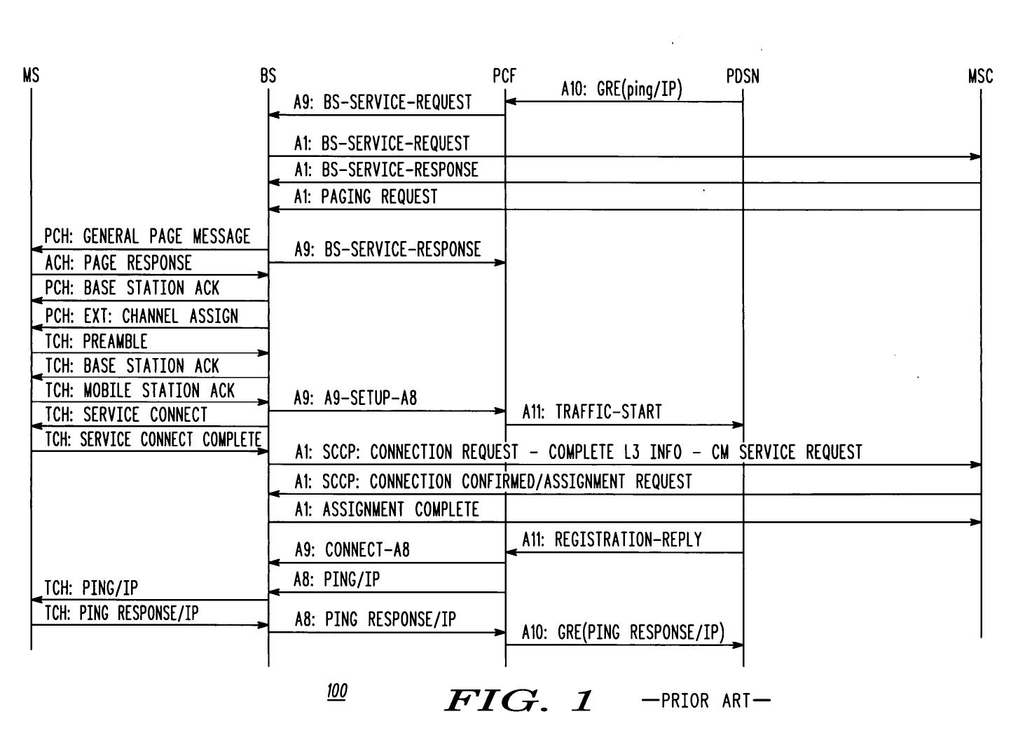

FIG. 2 is a block diagram depiction of a wireless communication system in accordance with multiple embodiments of the present invention.

FIG. 3 is a block diagram depiction of a wireless communication system in accordance with multiple embodiments of the present invention.

FIG. 4 is a messaging flow diagram depicting voice call presence messaging independent of a wireless presence proxy (WPP) in accordance with multiple embodiments of the present invention.

FIG. 5 is a messaging flow diagram depicting opportunistic presence messaging and WPP registration messaging in accordance with multiple embodiments of the present invention.

FIG. 6 is a messaging flow diagram depicting a WPP caching presence information for a mobile station (MS) and opportunistically updating the MS in accordance with multiple embodiments of the present invention.

FIG. 7 is a messaging flow diagram depicting presence messaging by a WPP in response to a registration event in accordance with multiple embodiments of the present invention.

FIG. 8 is a messaging flow diagram depicting presence messaging by a WPP in response to an origination event in accordance with multiple embodiments of the present invention.

### DETAILED DESCRIPTION OF EMBODIMENTS

The need to facilitate wireless presence-based services more efficiently is addressed by embodiments of the present invention. In general, a wireless presence proxy (WPP) caches presence updates (such as buddy list presence updates) from a presence server for a mobile station (MS). The WPP maintains presence information, which reflects the presence updates received, for transfer to the MS when an update condition exists. Thus, updates are made when, for example, a resource-efficient condition is present, such as the assignment of a traffic channel for other call activity. The WPP also updates the presence server, on behalf of the MS, when the MS presence status changes. In this manner, the embodiments described are able to reduce the system resources required to facilitate wireless presence-based services.

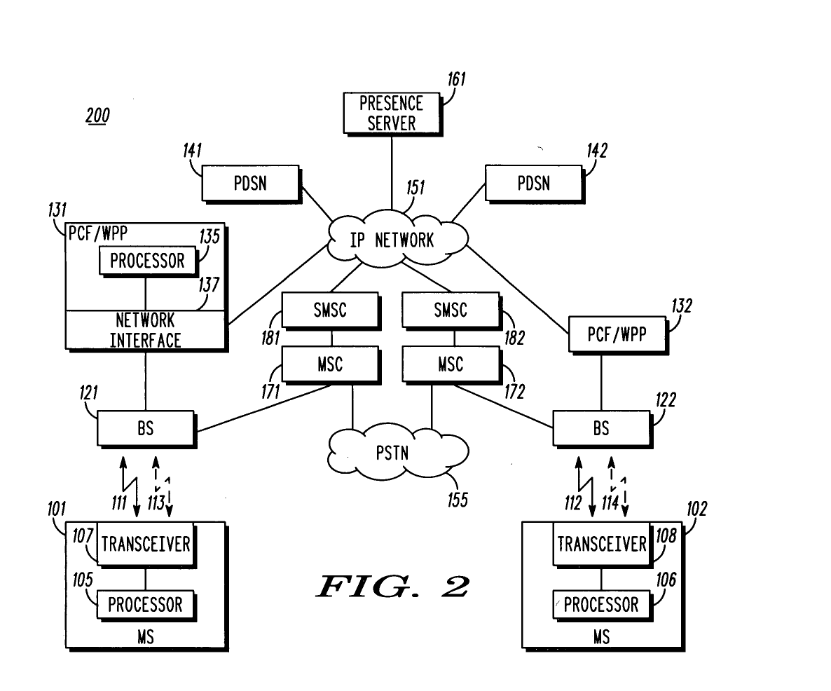

The disclosed embodiments can be more fully understood with reference to FIGS. 2-8. FIG. 2 is a block diagram depiction of a mobile communication system 200 in accordance with multiple embodiments of the present invention. Communication system 200 is a well-known Code Division Multiple Access (CDMA) system, specifically a cdma2000 system, which is based on the Telecommunications Industry Association/Electronic Industries Association (TIA/EIA) standards IS-2000 and IS-2001, suitably modified to implement the present invention. Alternative embodiments of the present invention may be implemented in communication systems that employ other technologies sufficiently similar to IS-2000 and IS-2001. Examples include, but are not limited to, IS-136, IS-95, IS-833, WCDMA, HRPD (TIA-878-1 and TIA-1878), “iDEN,” “WiDEN,” GSM, GPRS, UMTS, and EDGE.

Those skilled in the art will recognize that FIG. 2 does not depict all of the network equipment necessary for system 200 to operate but only those system components and logical entities particularly relevant to the description of embodiments of the present invention. In particular, the network equipment of system 200 comprises components such as base stations (BSs) 121 and 122, mobile switching centers (MSCs) 171 and 172, Short Message Service Centers (SMSCs) 181 and 182, packet control functions (PCFs)/wireless presence proxies (WPPs) 131 and 132, packet data serving nodes (PDSNs) 141 and 142, internet protocol (IP) network 151, public switched telephone network (PSTN) 155, and presence server 161. Generally, BSs, MSCs, SMSCs, PCFs, PDSNs, IP networks, PSTNs, and presence servers are known in the art. For example, BSs are well-known to comprise components such as base station controllers (BSCs) and base transceiver systems (BTSs), neither of which are specifically shown in FIG. 2. Also, although depicted as a single presence server, presence server 161 may represent multiple servers each for individual services such as IM and/or push-to-talk (PTT). In addition, PCFs are well-known to comprise components such as processors and network interfaces.

WPPs, like PCFs, can be implemented using well-known components such as, but not limited to, microprocessors, microcontrollers, memory devices, and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement a WPP that performs the given logic. Therefore, PCF/WPPs 131 and 132 represent common platforms that support both WPP functionality and PCF functionality.

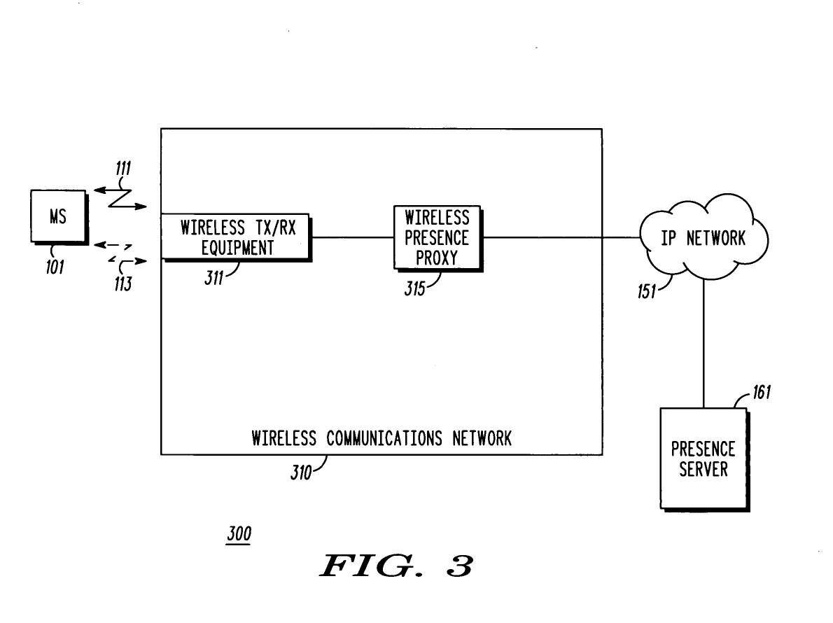

However, WPPs need not be implemented with PCFs. For example, FIG. 3 is a block diagram depiction of a mobile communication system 300 in which WPP 315 is merely depicted as part of wireless communications network 310 along with wireless transceiver equipment 311. Thus, a WPP may instead be implemented as a stand-alone system component (e.g., a control function), incorporated into well-known system components (such as a control function within an MSC, PCF, or BS), or distributed across well-known system components such as an MSC, PCF, or BS.

As depicted in FIG. 2, BSs 121 and 122 use air interfaces comprising channels 111-114 for communication with remote units 101 and 102. IS-2000 channels 111 and 112 each comprises a variety of well-known non-traffic channel types, such as broadcast channels, paging channels, access channels (i.e., access channels (ACHs) and enhanced access channels (EACHs)), and common control channels. IS-2000 channels 113 and 114 each comprise dedicated traffic channels, which are dynamically assigned and de-assigned to support user services.

IS-2000 terminology refers to remote units as mobile stations (MSs); however, remote units are not necessarily mobile or able to move. Thus, remote unit/MS platforms are known in the art to include devices such as mobile phones, computers, personal digital assistants, gaming devices, etc. In particular, MSs 101 and 102 each respectively comprise processors 105 and 106, transceivers 107 and 108, keypads (not shown), speakers (not shown), microphones (not shown), and displays (not shown). Processors, transceivers, keypads, speakers, microphones, and displays as used in MSs are all well-known in the art.

For example, MS processors are known to comprise basic components such as, but not limited to, microprocessors, digital signal processors (DSPs), microcontrollers, memory devices, and/or logic circuitry. Such MS components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement an MS that performs the given logic. Thus, MSs 101 and 102 represent known MSs that have been adapted, in accordance with the description herein, to implement embodiments of the present invention.

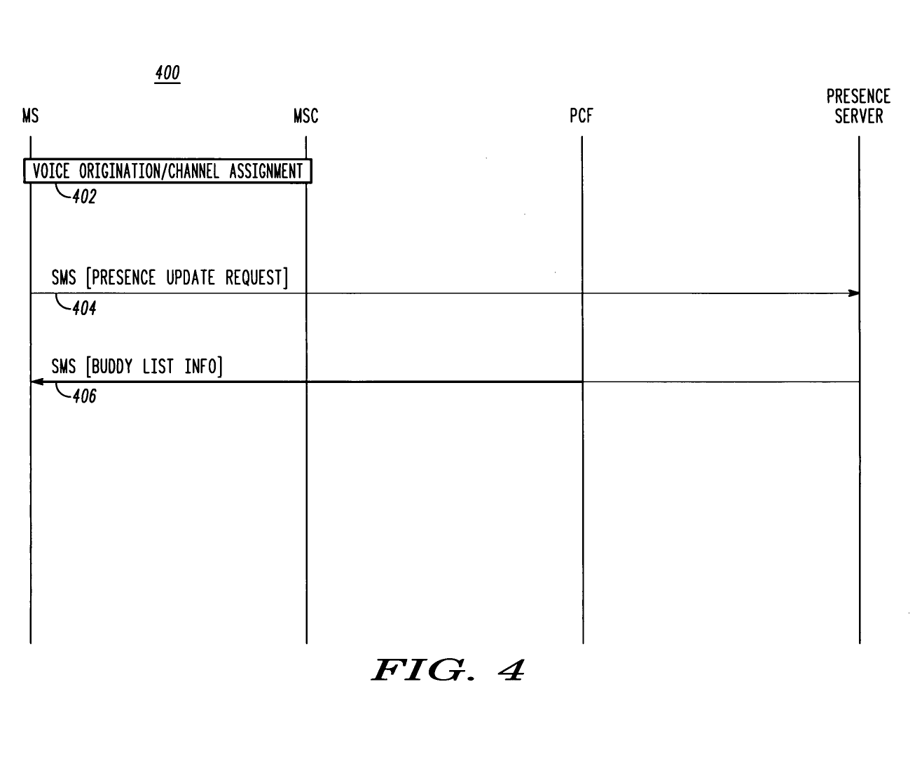

Operation of communication system 200 in accordance with multiple embodiments of the present invention occurs substantially as follows. Although system 200 comprises WPPs, a portion of the embodiments supported by the present invention do not require a WPP at all. For example, FIG. 4 is a messaging flow diagram (400) depicting voice call presence messaging independent of a wireless presence proxy (WPP) in accordance with multiple embodiments of the present invention. Messaging 402 represents call origination and channel assignment messaging involving MS 101, BS 121, and MSC 171. Although messaging 402 includes an origination message for a voice call from processor 105 via transceiver 107, it could instead include an origination message for a data call. Messaging 402 also includes a traffic channel (TCH) assignment to support the call request, which is received by processor 105 via transceiver 107. The origination message and channel assignment are conveyed via air interface resource 111.

Messaging 404 represents a presence update request message sent to presence server 161 by processor 105 via transceiver 107. Since MS 101 is involved in a voice call, the presence update request is sent to presence server 161 via short message service (SMS) messaging and TCH 113. In response, processor 105 receives updated buddy list presence information (represented by messaging 406) from presence server 161 via SMS/e-mail messaging, TCH 113, and transceiver 107. The presence update request (messaging 404) is routed by MSC 171 to SMSC 181. SMSC 181 sends the content of the SMS message to presence server 161. Presence server 161, knowing that MS 101 is now on a TCH, sends a presence update response to MS 101 (presence server 161 to SMSC 181, SMSC 181 to MSC 171, MSC 171 to BS 121, then BS 121 to MS 101). Thus, without requiring a WPP, a unit may indicate to a presence server that it has a TCH and may opportunistically receive presence updates using that TCH. This is more resource efficient than prior art presence updates which involve obtaining a TCH merely for presence updates independent of call activity.

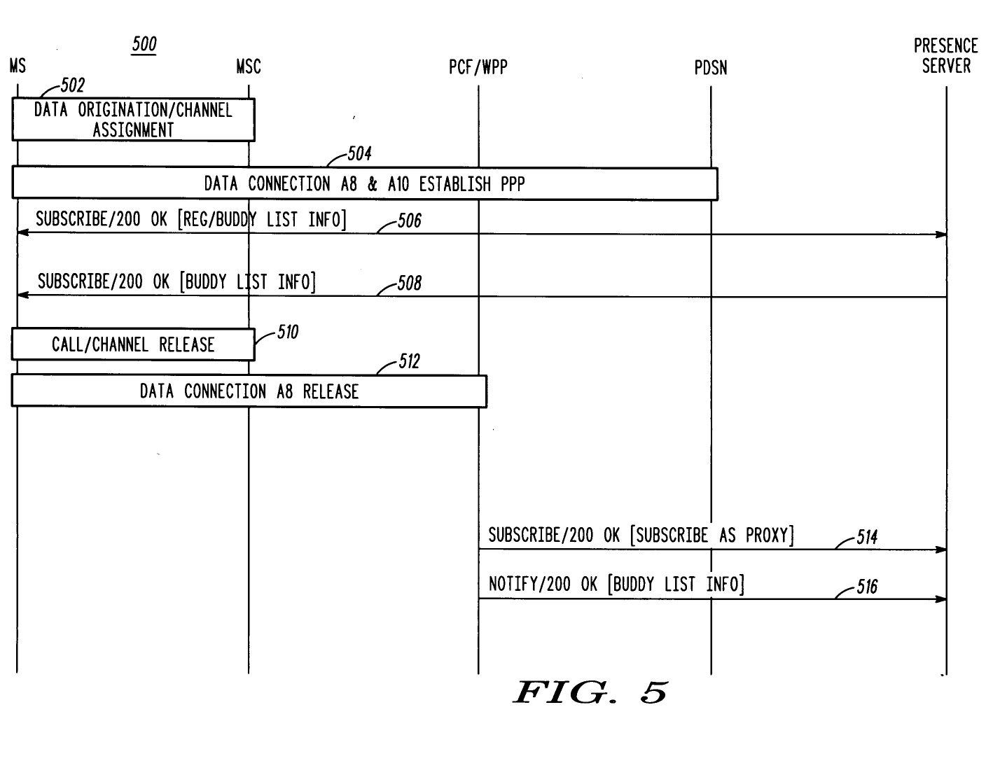

FIG. 5 is a messaging flow diagram (500) depicting opportunistic presence messaging and WPP registration messaging in accordance with multiple embodiments of the present invention. Messaging 502 represents call origination and channel assignment messaging involving MS 101, BS 121, and MSC 171. Messaging 502 includes an origination message (or alternatively a reconnect message) for a data call from processor 105 via transceiver 107. Messaging 502 also includes a traffic channel assignment to support the call request (TCH 113), which is received by processor 105 via transceiver 107. The origination message and channel assignment are conveyed via air interface resource 111.

Messaging 504 represents data connection establishment involving MS 101, BS 121, PCF/WPP 131, and PDSN 141. In the embodiments depicted by FIG. 5, MS 101, in an active data session via TCH 113, subscribes to a presence service provided by presence server 161. This is represented by messaging 506. The MS 101 subscription is directly with presence server 161; however, it occurs via PCF/WPP 131. While MS 101's data session is active, MS 101 may receive presence update information, such as the current status of its associated buddy list members, from presence server 161 as represented by messaging 508.

When MS 101 completes the data call, its session transitions from active to dormant; TCH 113 is released (messaging 510) and the data connection is torn down (messaging 512). When PCF/WPP 131, detects that MS 101 has gone dormant (e.g., its associated A8 connection being released), WPP processor 135 via network interface 137 subscribes (messaging 514) to the presence service as a proxy for MS 101. As MS 101's presence proxy, then, WPP processor 135 via network interface 137 subsequently receives presence update messaging from presence server 161 on behalf of MS 101.

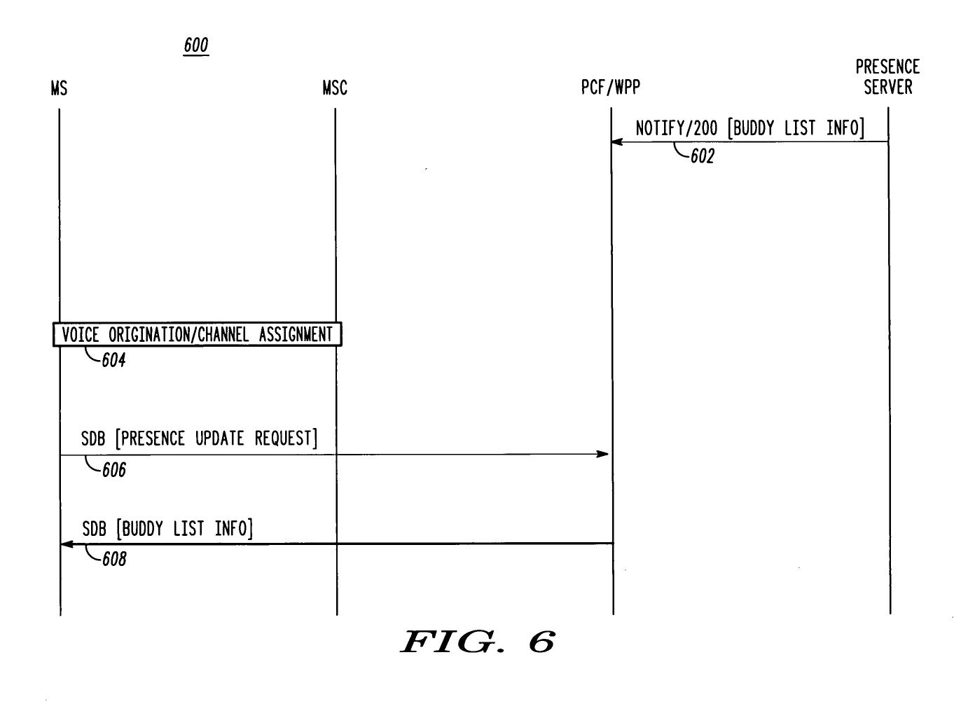

FIG. 6 is a messaging flow diagram (600) depicting PCF/WPP 131 caching presence information for MS 101 and opportunistically updating MS 101 in accordance with multiple embodiments of the present invention. Thus, in some embodiments supported by the present invention, PCF/WPP 131 caches presence information received for MS 101 until a resource efficient opportunity arises to update MS 101. Messaging 602 represents a buddy list presence update for MS 101 from presence server 161. WPP processor 135 receives the update via network interface 137 and uses it to update any buddy list presence information already cached for MS 101. Thus, this buddy list presence information for MS 101 is maintained over time to reflect the most recent buddy list presence updates received by PCF/WPP 131 for MS 101.

WPP processor 135 updates MS 101 with presence information from this maintained information when certain conditions exist. In some embodiments, a predefined period of time may be set to ensure that MS 101 is updated at least as often as this period elapses. For example, this time period may be measured from the time that the oldest change was made to MS 101's maintained information since the last update.

In general, PCF/WPP 131 should update MS 101 with presence information when wireless resource-efficient conditions are present. Such conditions include times when MS 101 is assigned a TCH for other services. The presence updates can thus be sent using already assigned resources rather than having to allocate separate resources. Also, when MS 101 is in semi-dormant mode, information known about MS 101's location can enable more efficient resource use, e.g., limiting use to only resources in the location of MS 101. Therefore, when updates are cached and PCF/WPP 131 receives an indication that MS 101 is assigned a TCH or an indication that MS 101 is in a semi-dormant mode, presence information is sent to MS 101. Examples of indications that MS 101 is assigned a TCH include an indication of a call origination by MS 101, an indication of call activity involving MS 101, and an indication of a TCH assignment to MS 101. FIG. 6 illustrates an example of utilizing resource-efficient conditions.

Messaging 604 represents call origination and channel assignment messaging involving MS 101, BS 121, and MSC 171. Messaging 604 includes a traffic channel assignment for TCH 113 to support MS 101's call origination. This channel assignment is received by processor 105 via transceiver 107. If messaging 604 involved a data call origination, a reconnect, or a semi-dormant transition, PCF/WPP 131 would be involved in the data connection establishment and thus aware that MS 101 was assigned a TCH. However, since messaging 604 involves a voice call origination, PCF/WPP 131 requires some other indication of MS 101's TCH assignment. In some embodiments, MS 101 provides such an indication. For example, as represented by messaging 606, processor 105 sends a presence update request to PCF/WPP 131 via transceiver 107 and TCH 113. This request may also indicate the type of call MS 101 has requested, a voice call in this example.

In response to MS 101's request, WPP processor 135 via network interface 137 sends presence information (messaging 608) from the buddy list presence information it has been maintaining to update MS 101. This presence information is received by MS processor 107 via TCH 113 and transceiver 107. Just as the call request in messaging 604 may be sent by MS 101 via short data burst (SDB) messaging, so too may the presence information from PCF/WPP 131 be received by MS 101 via SDB messaging. In some alternative scenarios, however, such as those in which MS 101 is involved in a data call, MS 101 may instead receive the presence information simply in the form of ordinary data on. TCH 113.

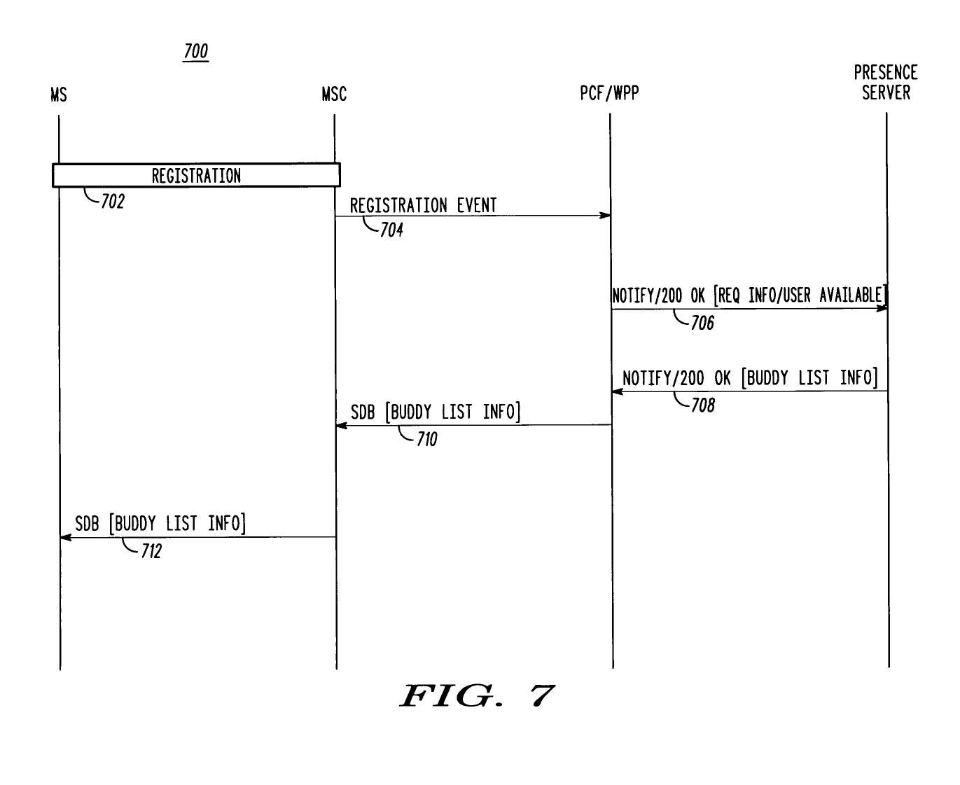

FIG. 7 is a messaging flow diagram (700) depicting presence messaging by PCF/WPP 131 in response to a registration event in accordance with multiple embodiments of the present invention. Another condition for updating MS 101 exists when PCF/WPP 131 receives an indication of a registration by the MS. In response to registration messaging 702 that involves MS 101, BS 121, and MSC 171, MSC 171 sends PCF/WPP 131 an indication of MS 101's registration (messaging 704). In addition to caching presence updates for MS 101, PCF/WPP 131 also provides presence server 161 updates on MS 101's presence-related status.

For example, messaging 706 represents such an update to presence server 161. Specifically, WPP processor 135 via network interface 137 updates presence server 161 with a status of available for MS 101 in response to receiving an indication of MS 101's registration. Another situation in which PCF/WPP 131 may provide an available status update for MS 101 would be in response to receiving an indication of an available-busy for MS 101. Similarly, PCF/WPP 131 may provide an unavailable status update for MS 101 in response to receiving indications such as an indication of a cellular deregistration by MS 101, an indication of a “power off” by MS 101, an indication of a presence deregistration by MS 101, or an indication of an application service deregistration by MS 101.

In response to the status update of messaging 706, presence server 161 may send presence updates for members of MS 101's buddy list (messaging 708). Since in the example of FIG. 7 MS 101 has only registered, MS 101 is not assigned a TCH. However, PCF/WPP 131 and MSC 171 can opportunistically leverage MS 101's registration information to direct paging channel (PCH) messaging to MS 101's location. Thus, as depicted by messaging 710 and 712, a buddy list update may be conveyed to MS 101 via SDB on a PCH of air interface resource 111.

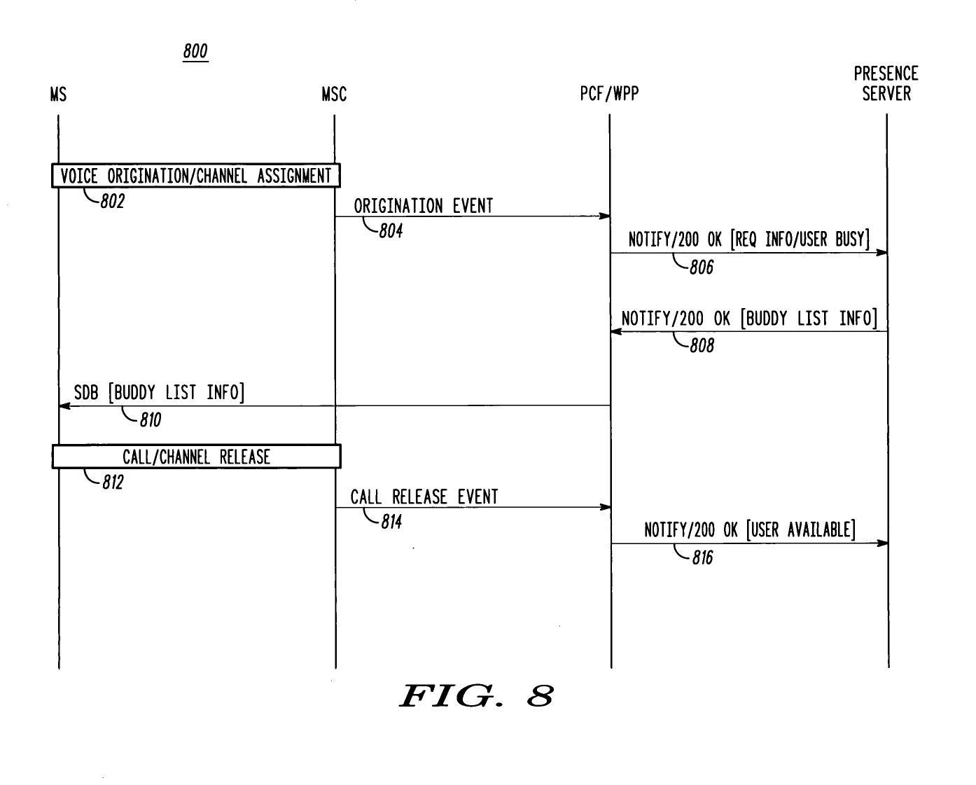

FIG. 8 is a messaging flow diagram (800) depicting presence messaging by PCF/WPP 131 in response to an origination event in accordance with multiple embodiments of the present invention. Messaging 802 represents call origination and channel assignment messaging involving MS 101, BS 121, and MSC 171. Messaging 802 includes a traffic channel assignment for TCH 113 to support MS 101's call origination. If messaging 802 involved a data call origination, a reconnect, or a semi-dormant transition, PCF/WPP 131 would be involved in the data connection establishment and thus aware that MS 101 was assigned a TCH. However, since messaging 802 involves a voice call origination, PCF/WPP 131 requires some other indication of MS 101's TCH assignment. In some embodiments, MS 101 provides such an indication. This was discussed above with respect to FIG. 6. In other embodiments, MSC 171 provides messaging 804 to indicate that an origination event for MS 101 has occurred.

As depicted in FIG. 8, PCF/WPP 131 provides presence server 161 updates on MS 101's presence-related status. Messaging 806 and 816 represent such updates. Specifically, WPP processor 135 via network interface 137 updates presence server 161 with a status of busy for MS 101 in response to receiving an indication of MS 101's call origination. Another situation in which PCF/WPP 131 may provide a busy status update for MS 101 would be in response to receiving an indication of call involvement by MS 101 (e.g., when receiving an indication of a page response from MS 101).

In response to the status update of messaging 806, presence server 161 may send presence updates for members of MS 101's buddy list (messaging 808). In the example of FIG. 8 MS 101 has been assigned TCH 113. Thus, PCF/WPP 131 can opportunistically leverage MS 101's TCH 113 to provide a buddy list update.

When MS 101 completes the voice call and TCH 113 is released (messaging 812), PCF/WPP 131 receives an indication (messaging 814) from MSC 171 that MS 101 has completed its voice call. In response to receiving the indication of MS 101's call completion, PCF/WPP 131 updates presence server 161 with a status of available on behalf of MS 101.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

1. A method for facilitating wireless presence-based services comprising:
receiving, by a wireless presence proxy (WPP) from a presence server, a buddy list presence update for a mobile station (MS);
maintaining, by the WPP, buddy list presence information reflecting the buddy list presence update for the MS; and
when a condition for updating the MS exists, sending, by the WPP, presence information from the buddy list presence information to update the MS.

2. The method of claim 1, further comprising
subscribing, by the WPP, to a presence service from the presence server as a proxy for the MS.

3. The method of claim 1, wherein a condition for updating the MS exists when a predefined period of time has elapsed.

4. The method of claim 3, wherein a condition for updating the MS exists when a predefined period of time has elapsed since an oldest change to the buddy list presence information.

5. The method of claim 1, wherein a condition for updating the MS comprises a wireless resource-efficient condition for updating the MS.

6. The method of claim 5, wherein a condition for updating the MS exists when the WPP receives an indication that the MS is assigned a traffic channel (TCH).

7. The method of claim 6, wherein the indication that the MS is assigned a TCH comprises an indication from the group consisting of an indication of a call origination by the MS, an indication of call activity involving the MS, and an indication of a TCH assignment to the MS.

8. The method of claim 6, wherein the presence information is sent to the MS via the TCH.

9. The method of claim 8, wherein the presence information is sent to the MS via short data burst (SDB) messaging.

10. The method of claim 8, wherein the presence information is sent to the MS as data on the TCH.

11. The method of claim 1, wherein a condition for updating the MS exists when the WPP receives an indication that the MS is in a semi-dormant mode.

12. The method of claim 1, wherein a condition for updating the MS exists when the WPP receives a presence update request from the MS.

13. The method of claim 1, wherein a condition for updating the MS exists when the WPP receives an indication of a registration by the MS.

14. The method of claim 1, wherein the presence information is sent to the MS via a PCH.

15. The method of claim 14, wherein the presence information is sent to the MS via short data burst (SDB) on the PCH.

16. The method of claim 1, further comprising updating, by the WPP, a presence server with a status of available for the MS in response to receiving an indication from the group consisting of an indication of a call completion by the MS and an indication of a registration by the MS.

17. The method of claim 1, wherein the buddy list presence information contains the most recent information received by the WPP.

18. The method of claim 1, further comprising updating, by the WPP, a presence server with a status of unavailable for the MS in response to receiving an indication from the group consisting of an indication of a deregistration by the MS, an indication of a “power off” by the MS, an indication of a presence deregistration by the MS, and an indication of an application service deregistration by the MS.

19. The method of claim 1, further comprising updating, by the WPP, a presence server with a status of busy for the MS in response to receiving an indication from the group consisting of an indication of a call origination by the MS and an indication of call involvement by the MS.

20. The method of claim 1, further comprising updating, by the WPP, a presence server with a status of available for the MS in response to receiving an indication from the group consisting of an indication of a registration by the MS and an indication of available-busy for the MS.

21. A method for facilitating wireless presence-based services comprising:
sending, by a mobile station (MS), a call request;
receiving, by the MS, a traffic channel (TCH) assignment to support the call request; and
receiving, by the MS, updated buddy list presence information via the TCH supporting the call request.

22. The method of claim 21, wherein receiving the updated buddy list presence information comprises receiving the updated buddy list presence information from a wireless presence proxy (WPP).

23. The method of claim 22, further comprising sending, by the MS, a presence update request to the WPP via the TCH supporting the call request, wherein the updated buddy list presence information is received in response to the presence update request.

24. The method of claim 22, further comprising sending, by the MS, an indication to the WPP that the MS is on a TCH.

25. The method of claim 22, further comprising sending, by the MS, an indication to the WPP of a call type associated with the call request being supported by the TCH.

26. The method of claim 22, wherein the call request comprises a message from the group consisting of an origination message, a page response message, and a reconnect message.

27. The method of claim 22, wherein the call request comprises a request from the group consisting of a data call request and a voice call request.

28. The method of claim 22, wherein the call request is sent via short data burst (SDB) and wherein the updated buddy list presence information is received via SDB.

29. The method of claim 21, wherein receiving the updated buddy list presence information comprises receiving the updated buddy list presence information from a presence server.

30. The method of claim 29, further comprising sending, by the MS, a presence update request message to the presence server.

31. The method of claim 30, wherein sending the presence update request message comprises sending the presence update request message to the presence server when the call request is a voice call request.

32. A wireless presence proxy (WPP) for facilitating wireless presence-based services, the WPP comprising:
a network interface adapted to send and receive messaging using at least one communication protocol;
a processor, communicatively coupled to the network interface,
adapted to receive, from a presence server via the network interface, a buddy list presence update for a mobile station (MS),
adapted to maintain buddy list presence information reflecting the buddy list presence update for the MS, and
adapted to send, via the network interface, presence information from the buddy list presence information to update the MS, when a condition for updating the MS exists.

33. A mobile station (MS) for facilitating wireless presence-based services, the MS comprising:
a transceiver; and
a processor, communicatively coupled to the transceiver,
adapted to send a call request via the transceiver,
adapted to receive a traffic channel assignment (TCH) to support the call request via the transceiver, and
adapted to receive an updated buddy list presence information via the TCH supporting the call request and the transceiver.
